(19) United States
(12) Patent Application Publication
(10) Pub. No.: US 2017/0312976 A1
(43) Pub. Date: Nov. 2, 2017

(54) PREFORM FOR LIQUID BLOW MOLDING

(71) Applicant: DISCMA AG, Hunenberg (CH)

(72) Inventors: Toshimasa TANAKA, Tokyo (JP); Yuichi OKUYAMA, Kanagawa (JP); Shinichi TABATA, Kanagawa (JP)

(73) Assignee: DISCMA AG, Hunenberg (CH)

(21) Appl. No.: 15/522,640

(22) PCT Filed: Sep. 17, 2015
(86) PCT No.: PCT/JP2015/004770

§ 371 Date: Apr. 27, 2017

(30) Foreign Application Priority Data
Oct. 30, 2014 (JP) 2014-221473
Aug. 31, 2015 (JP) 2015-170945

(51) Int. Cl. B29C 49/46; B29C 49/00; B29K 667/00; B29K 67/00; B29L 31/00

(52) U.S. Cl. CPC B29C 49/46; B29C 49/0005; B29K 2667/003; B29C 2049/4664; B29C 2049/465; B29L 2031/7158; B29K 2067/003

(57) ABSTRACT

A PET preform from which a container of a desired shape can be accurately molded by liquid blow molding. A configuration is adopted where the preform has a bottomed cylinder shape provided with a mouth portion and a body portion and, when molded by liquid blow molding into a container, the body portion is stretched in an axial direction at a stretch ratio of 1.50 or more and 3.10 or less and is stretched in a radial direction at a stretch ratio of 2.26 or more and 3.70 or less.

### BACKGROUND

### Field of the Invention

The present invention relates to a preform for liquid blow molding. More specifically, the invention relates to a preform that is formed of polyethylene terephthalate into a bottomed cylinder provided with a mouth portion and a body portion and molded by liquid blow molding into a container.

### Description of Related Technology

Containers made of polyethylene terephthalate (“PET” herein below), as represented by so-called PET bottles, are used in various applications, such as for beverages, for foods, and for cosmetics.

Such containers are generally molded into a predetermined shape by heating a preform made of PET, formed by injection molding, compression molding, or the like, into a bottomed cylinder integrally provided with a cylindrical mouth portion and a test-tube-shaped body portion until a stretch effect is expressed and, in this state, supplying pressurized air into the preform, while using a stretch rod, to stretch the preform in an axial direction and a radial direction (for example, see JP 2014-88004A). Moreover, by filling the molded container with a liquid, such as a beverage in a subsequent process, a product is provided.

### SUMMARY

However, with a conventional preform made of PET, there is a problem where, in attempting to air blow mold a container into a shape where a stretch ratio in a radial direction is low, a traceability to a mold shape becomes low and, in conjunction with contraction of the container arising after molding, a container of a desired capacity and height cannot be obtained.

In contrast, also known is liquid blow molding where, by supplying a pressurized liquid (instead of pressurized air) to a preform made of PET, the preform is molded into a container of a predetermined shape; however, not known is at what stretch ratio the preform should be stretched when molding by liquid blow molding into the container to obtain a favorable container.

The present invention is made in view of such problems and has as an object to provide a preform made of PET from which a container of a desired shape can be accurately molded by liquid blow molding.

In overcoming the above drawbacks and limitations, a PET preform is provided for liquid blow molding, having a bottomed cylinder provided with a mouth portion and a body portion, wherein by liquid blow molding, the body portion is molded into a container by being stretched in an axial direction at a stretch ratio of 1.50 or more and 3.10 or less and being stretched in a radial direction at a stretch ratio of 2.26 or more and 3.70 or less.

With a preform for liquid blow molding according to the principles of the present invention, in the above configuration, preferably, the stretch ratio in the radial direction of the body portion by liquid blow molding is 2.26 or more and less than 2.88.

With a preform for liquid blow molding according to the principles of the present invention, in the above configuration, preferably, the stretch ratio in the axial direction of the body portion by liquid blow molding is 1.50 or more and less than 3.00 and the stretch ratio in the radial direction of the body portion by liquid blow molding is 2.26 or more and 3.10 or less.

According to the present invention, a preform made of PET from which a container of a desired shape can be accurately molded by liquid blow molding can be provided.

### BRIEF DESCRIPTION OF DRAWINGS

FIG. 1 is a partial, cross-sectional side view of a preform that the principles embodies of the present invention.

FIG. 2 is a plot diagram illustrating test results where preforms made of PET, as represented in Table 1, are molded into containers by liquid blow molding.

[FIG. 3 is a plot diagram illustrating test results where the preforms made of PET, as represented in Table 1 are molded into containers by air blow molding.

FIG. 4 is a plot diagram illustrating the test results presented in Table 2.

### DETAILED DESCRIPTION

A preform embodying the principles of the present invention is illustrated and described more specifically below with reference to the drawings.

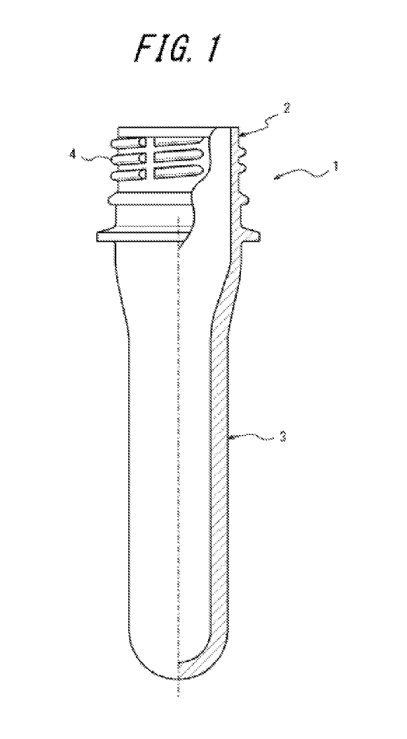

A PET (polyethylene terephthalate) preform 1 that embodies the present invention is illustrated in FIG. 1 and is made by injection molding and formed so as to have a bottomed cylinder provided with a mouth portion 2 and a body portion 3. This preform 1 is not limited to being formed by injection-molding of PET and can also be formed by, for example, molding PET into a predetermined shape by compression molding or extrusion blow molding. The mouth portion 2 of the preform 1 is formed into a cylinder, and a male thread portion 4 is integrally provided on an outer peripheral surface thereof. The body portion 3 is formed into a generally cylindrical test-tube shape with a circular cross section extending along an axial direction and which is provided, below the mouth portion 2, coaxially and integrally with the mouth portion 2.

This preform 1 is used in liquid blow molding in which a pressurized liquid is supplied to the body portion 3 through the mouth portion 2, and the body portion 3 is stretched in the axial direction and a radial direction thereof to be molded into a container of a predetermined shape. That is, the preform 1 is molded into a container of a predetermined shape conforming to an inner surface of a cavity of a mold by the body portion 3 first being mounted in a cavity of a mold for blow molding (that is not illustrated) and then being stretched in the axial and radial directions thereof by the pressurized liquid supplied through the mouth portion 2.

Note that as the liquid supplied to the preform 1 during liquid blow molding, it is preferable to use the liquid to be ultimately filled in the container as the product, such as a beverage, a cosmetic, a drug, a detergent, or a body soap. By doing so, a secondary filling process of the liquid into the molded container can be omitted, increasing productivity.

When liquid blow molding as above, it is preferable to heat the body portion 3 of the preform 1 in advance, by a heater or the like, to a temperature where a stretch effect is expressed. Moreover, when liquid blow molding, a configuration can be adopted where a stretch rod is inserted inside the body portion 3 through the mouth portion 2 and stretching in the axial direction of the body portion 3 is assisted by this stretch rod. Note that when heating the preform 1, in consideration of productivity, a molding process according to a so-called hot preform method where, for example, residual heat from the time of initial preform molding is used, can also be adopted.

The preform 1 of the present invention is molded by liquid blow molding into the container of the predetermined shape by the body portion 3 being stretched in the axial direction thereof at a stretch ratio of 1.50 or more and 3.10 or less and in the radial direction at a stretch ratio of 2.26 or more and 3.70 or less. A more preferable range of the stretch ratio in the radial direction of the body portion 3 of the preform 1 according to the principles of the present invention in liquid blow molding is 2.26 or more and less than 2.88.

The stretch ratios in the axial direction and the radial direction of the preform 1 during liquid blow molding can be set to the above ranges by making various modifications to an axial-direction dimension and a radial-direction dimension (inner-diameter dimension) of the cavity of the mold for blow molding relative to an axial-direction dimension and a radial-direction dimension (outer-diameter dimension) of the body portion 3 of the preform 1 or making various modifications to the axial-direction dimension and the radial-direction dimension (outer-diameter dimension) of the body portion 3 of the preform 1 relative to the axial-direction dimension and the radial-direction dimension (inner-diameter dimension) of the cavity of the mold for blow molding.

By the body portion 3 being stretched during liquid blow molding in the axial direction and the radial direction thereof at the stretch ratios of the above ranges, the preform 1 of the present invention sufficiently traces the inner surface of the cavity of the mold and is accurately molded into a container of a desired shape, having a desired capacity, height, and the like, without giving rise to inordinate contraction of the molded container and without rupturing the container during molding.

Furthermore, with the preform 1 of the present invention, the stretch ratio in the axial direction of the body portion 3 by liquid blow molding is preferably 1.50 or more and less than 3.00 and the stretch ratio in the radial direction of a body portion 4 by liquid blow molding is preferably 2.26 or more and 3.10 or less. By stretching the body portion 3 in the axial direction and the radial direction thereof at stretch ratios of such ranges, the container can be accurately molded into the desired shape having the desired capacity, height, and the like and voids (minute cavities included in an object, i.e. pores) arising in the molded container and reducing a transparency thereof can be prevented, thereby enabling molding of a container with high transparency and a favorable appearance.

Stretch ratios in the axial direction and the radial direction of the body portion of the preform, at which a preform formed of PET can be accurately molded by liquid blow molding into the container of the desired shape and the corresponding influence of the stretch ratios in the axial direction and the radial direction on molding favorability of the container obtained by liquid blow molding, using three types of preforms made of PET (Nos. 1 to 3) where shapes of the body portions differ from each other and seven types of molds, where the axial-direction dimensions and the radial-direction dimensions of the cavities differ from each other and liquid blow molding while making various modifications to the stretch ratio in the axial direction (ASR) and the stretch ratio in the radial direction (HSR), are presented in Table 1. Note that for comparison, table 1 also indicates determinations regarding molding favorability of these containers in a situation where the preforms are molded into containers by air blow molding under similar conditions.

TABLE 1

| | |
|---|---|
| Stretch ratio | PET |

| No | ASR | HSR | PSR | Liquid blowing | Air blowing |
|---|---|---|---|---|---|
| 1 | 1.50 | 3.50 | 5.25 | ◯ | ◯ |
| | 2.00 | 2.75 | 5.50 | ◯ | X |
| | 2.00 | 4.50 | 9.00 | X | ◯ |
| | 2.75 | 3.50 | 9.63 | ◯ | ◯ |
| | 2.50 | 4.00 | 10.00 | X | ◯ |
| | 3.00 | 5.00 | 15.00 | X | ◯ |
| | 3.50 | 4.50 | 15.75 | X | X |
| 2 | 2.37 | 2.48 | 5.86 | ◯ | ◯ |
| | 3.16 | 1.95 | 6.14 | ◯ | X |
| | 3.16 | 3.19 | 10.05 | X | X |
| | 4.34 | 2.48 | 10.75 | X | X |
| | 3.94 | 2.83 | 11.17 | X | X |
| | 4.73 | 3.54 | 16.76 | X | X |
| | 5.52 | 3.19 | 17.69 | X | X |
| 3 | 1.69 | 2.88 | 4.87 | ◯ | ◯ |
| | 2.25 | 2.26 | 5.10 | ◯ | X |
| | 2.25 | 3.70 | 8.34 | ◯ | ◯ |
| | 3.10 | 2.88 | 8.92 | ◯ | ◯ |
| | 2.82 | 3.29 | 9.27 | ◯ | ◯ |
| | 3.38 | 4.11 | 13.90 | X | ◯ |
| | 3.94 | 3.70 | 14.60 | X | X |

As seen from Table 1, the molding favorability of the blow-molded container is determined based on a reduction ratio of an internal capacity of the molded container (contraction ratio of the molded container) and a reduction ratio of the height of the container after 1 day from the molding thereof (change over time). Note that in table 1, ◯ indicates that the moldability is favorable (the reduction rate relative to an initial internal capacity is 5% or less and a reduction rate relative to an initial container height is 1% or less) and × indicates that the moldability is unfavorable. Moreover, in a situation where the preform ruptures during blow molding and no container is formed, the molding favorability is determined to be ×. Table 1 lists for reference stretch ratios of a surface area of the body portion (PSR) of the preforms in addition to the stretch ratios in the axial direction (ASR) and the stretch ratios in the radial direction (HSR) of the preforms.

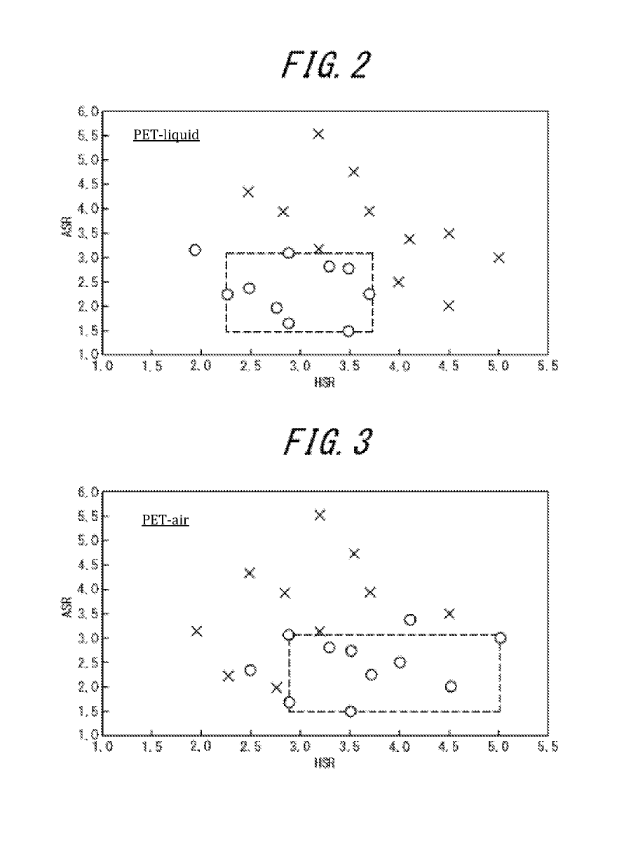

FIG. 2 is a plot diagram illustrating the results of Table 1 where the preforms made of PET were molded into containers by liquid blow molding, and FIG. 3 is a plot diagram illustrating the results of Table 1 where the preforms made of PET were molded into containers by air blow molding.

From the results illustrated in Table 1 and FIG. 2, it is understood that in the situation of molding the preform made of PET into the container of the predetermined shape by liquid blow molding, setting the stretch ratios in the axial direction and the radial direction so the stretch ratio in the axial direction of the body portion is 1.50 or more and 3.10 or less and the stretch ratio in the radial direction of the body portion is 2.26 or more and 3.70 or less enables the preform to be molded by liquid blow molding into the container with favorable moldability.

In contrast, from the results illustrated in Table 1 and FIG. 3, it is understood that in the situation of molding the preform made of PET into the container of the predetermined shape by air blow molding, moldability of the container can be ensured in a range where the stretch ratio in the radial direction is higher than is the case in liquid blow molding; however, it is also understood that, in contrast, the moldability of the container decreases in a range where the stretch ratio in the radial direction is lower, at less than 2.88, than is the case in liquid blow molding. That is, it is understood that in the situation of molding the preform made of PET into the container of the predetermined shape by liquid blow molding, setting the stretch ratios in the axial direction and the radial direction so the stretch ratio in the axial direction of the body portion is 1.50 or more and 3.10 or less and the stretch ratio in the radial direction is 2.26 or more and less than 2.88 enables molding with favorable moldability even for a container of a shape where the stretch ratio in the radial direction is low such that it cannot be molded by air blow molding.

Furthermore, from Table 1, it is understood that in the situation of molding the preform made of PET into the container of the predetermined shape by air blow molding, the preform may not be able to be molded even if the stretch ratio of the surface area thereof (PSR) is small; however, it is also understood that in the situation of molding the preform made of PET into the container of the predetermined shape by liquid blow molding, setting the stretch ratios in the axial direction and the radial direction of the preform so the stretch ratio of the surface area thereof (PSR) is 8.92 or more enables the preform to be molded into the container with reliability and favorable moldability.

Next, the preforms made of PET similarly to the those illustrated by Table 1, were examined for the influence of the stretch ratios in the axial direction and the radial direction on the molding favorability of the container obtained by liquid blow molding the preform using two types of molds (Nos. 1 and 2) where the axial-direction dimensions and the radial-direction dimensions of the cavities differ from each other and seventeen types of preforms and liquid blow molding, while making various modifications to the stretch ratio in the axial direction (ASR) and the stretch ratio in the radial direction (HSR) so these differ from those indicated in Table 1 and of evaluating a presence or absence of reduction in transparency due to voids for containers deemed to have favorable moldability. Test results thereof are indicated in Table 2. Note that Table 2 lists for reference a weight of the body portion (body-portion weight) of each preform and lists for reference stretch ratios of the surface area of the body portion (PSR) of the preforms in addition to the stretch ratios in the axial direction (ASR) and the stretch ratios in the radial direction (HSR) of the preforms.

TABLE 2

| | Body-portion | | | | PET | | |
|---|---|---|---|---|---|---|---|
| | wt. | Stretch ratio | | | | | Comp. |
| No | (g) | ASR | HSR | PSR | Moldability | Voids | eval. |
| 1 | 16.0 | 2.39 | 3.85 | 9.20 | X | — | X |
| | 18.0 | 2.23 | 4.08 | 9.10 | X | — | X |
| | 12.0 | 3.27 | 3.75 | 12.26 | X | — | X |
| | 20.0 | 2.29 | 3.88 | 8.43 | ◯ | X | Δ |
| | 18.1 | 2.55 | 3.58 | 9.13 | ◯ | X | Δ |
| | 26.2 | 1.86 | 3.07 | 5.71 | ◯ | ◯ | ◯ |
| | 16.5 | 3.58 | 3.05 | 10.92 | X | — | X |
| | 18.1 | 2.55 | 3.10 | 7.89 | ◯ | ◯ | ◯ |
| | 18.1 | 2.55 | 2.87 | 7.30 | ◯ | ◯ | ◯ |
| | 18.1 | 2.20 | 3.10 | 6.82 | ◯ | ◯ | ◯ |
| | 18.1 | 3.00 | 3.09 | 9.26 | ◯ | X | Δ |
| | 18.1 | 2.84 | 2.83 | 8.03 | ◯ | ◯ | ◯ |
| 2 | 15.0 | 2.58 | 3.22 | 8.62 | ◯ | X | Δ |
| | 15.0 | 2.49 | 2.87 | 7.14 | ◯ | ◯ | ◯ |
| | 15.0 | 2.16 | 3.05 | 6.57 | ◯ | ◯ | ◯ |
| | 14.0 | 2.55 | 3.48 | 8.85 | ◯ | X | Δ |
| | 11.0 | 3.12 | 3.25 | 10.12 | X | — | X |

As seen in Table 2, similarly to Table 1, the molding favorability of the blow-molded container is determined based on a reduction ratio of the internal capacity of the molded container (contraction ratio of the molded container) and the reduction ratio of the height of the container after 1 day from the molding thereof. Note that in Table 2, ◯ indicates that the moldability is favorable and × indicates that the moldability is unfavorable. Moreover, in a situation where the preform ruptures during blow molding and no container is formed, the molding favorability is determined to be ×.

Meanwhile, the evaluation of whether the transparency of the molded container is reduced due to voids is performed by visual confirmation: a situation where it can be visually determined that there is no reduction in transparency due to voids is determined as ◯, and a situation where it can be visually determined that there is a reduction in transparency due to voids is determined as ×. Note that this evaluation is not performed in a situation where the moldability is determined to be ×.

Furthermore, a comprehensive evaluation is performed combining the moldability evaluation and the evaluation of transparency reduction due to voids. In the comprehensive evaluation, a situation where both the moldability evaluation and the evaluation of transparency reduction due to voids are ◯ is determined as ◯ and a situation where the moldability evaluation is ◯ but the evaluation of transparency reduction due to voids is × is determined as Δ.

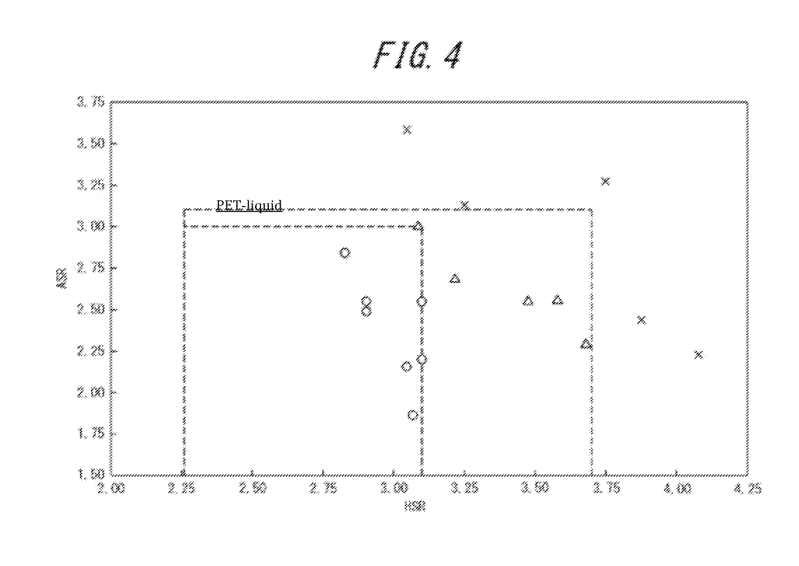

FIG. 4 is a plot diagram illustrating the results from Table 2. Note that in FIG. 4, the comprehensive evaluations presented in Table 2 are plotted as the results.

From the results illustrated in Table 2 and FIG. 4 as well, similarly to the results illustrated from Table 1 and FIG. 2, it is understood that in the situation of molding the preform made of PET into the container of the predetermined shape by liquid blow molding, setting the stretch ratios in the axial direction and the radial direction in ranges where the comprehensive evaluation in Table 2 becomes ◯ or Δ—that is, so the stretch ratio in the axial direction of the body portion is 1.50 or more and 3.10 or less and the stretch ratio in the radial direction of the body portion is 2.26 or more and 3.70 or less—enables the preform to be molded into the container with favorable moldability by liquid blow molding.

Meanwhile, it is also understood that while voids may arise in the molded container even in the ranges of the stretch ratios in the axial direction and the radial direction where the preform can be molded into the container with favorable moldability by liquid blow molding (range where Δ is plotted in FIG. 4), no transparency reduction due to voids arises in the molded container in a range where the stretch ratio in the axial direction of the body portion is 1.50 or more and less than 3.00 and the stretch ratio in the radial direction of the body portion is 2.26 or more and 3.10 or less. That is, it is understood that, with the preform made of PET, setting a range for liquid blow molding where the stretch ratio in the axial direction of the body portion is 1.50 or more and less than 3.00 and the stretch ratio in the radial direction of the body portion is 2.26 or more and 3.10 or less prevents transparency reduction due to voids while ensuring container moldability and enables molding into a container with high transparency and a favorable appearance.

It is needless to say that the present invention is not limited to the above embodiment and can be modified in various ways within a range that does not depart from the spirit of the invention.

For example, the preform 1 is not limited to the shape illustrated in FIG. 1 and can adopt various shapes as long as a relationship between the axial-direction dimension and the radial-direction dimension of the cavity of the mold for blow molding is such that the body portion is stretched at a stretch ratio of 1.50 or more and 3.10 or less in the axial direction and at a stretch ratio of 2.26 or more and 3.70 or less in the radial direction—for example, one of a shape relative to the shape illustrated in FIG. 1 where the axial-direction dimension of the body portion 3 is of a smaller ratio compared to the radial-direction dimension. Moreover, a temperature of the liquid after molding the preform 1—that is, a content liquid—is preferably 75° or less.

1. In combination, a preform and resultant container formed by liquid blow molding, the combination comprising:
a preform formed of polyethylene terephthalate as a bottomed cylinder with an open mouth portion and a body portion extending from the open mouth portion, and
wherein a resultant container formed by liquid blow molding of the preform has
a body portion molded into a container by being stretched in an axial direction exhibiting an axial stretch ratio of 1.50 or more and 3.10 or less and in a radial direction exhibiting a radial stretch ratio of 2.26 or more and 3.70 or less relative to the body portion of the preform.

2. The combination according to claim 1, wherein the radial stretch ratio in the radial direction of the body portion is 2.26 or more and less than 2.88.

3. The combination according to claim 1, wherein the axial stretch ratio in the axial direction of the body portion is 1.50 or more and less than 3.00 and the radial stretch ratio in the radial direction of the body portion is 2.26 or more and 3.10 or less.

4. A method for forming a resultant container from a preform by liquid blow molding, the method comprising:
providing a preform formed of polyethylene terephthalate as a bottomed cylinder having an open mouth portion and a body portion extending from the open mouth portion; and
liquid blow molding the preform into a resultant container, the step of liquid blow molding further comprising:
injecting a liquid into the preform through the open mouth portion, and
stretching the body portion in an axial direction with an axial stretch ratio of 1.50 or more and 3.10 or less and in a radial direction with a radial stretch ratio of 2.26 or more and 3.70 or less relative to a body portion of the resultant container.

5. The method according to claim 4, wherein the radial stretch ratio is 2.26 or more and less than 2.88.

6. The method according to claim 4, wherein the axial stretch ratio is 1.50 or more and less than 3.00 and the radial stretch ratio is 2.26 or more and 3.10 or less.
